(19) United States
(12) Patent Application Publication
(10) Pub. No.: US 2021/0340001 A1
(43) Pub. Date: Nov. 4, 2021

(54) METHOD AND APPARATUS FOR MONITORING A BEVERAGE POST-MIX SYSTEM (BIB METER)

(71) Applicant: Speedway LLC, ENON, OH (US)

(72) Inventors: Alexander C. Heck, Dayton, OH (US); Robert W. Howard, Dayton, OH (US); Matthew J. Wenning, Dayton, OH (US)

(73) Assignee: Speedway LLC, ENON, OH (US)

(21) Appl. No.: 17/246,876

(22) Filed: May 3, 2021

Related U.S. Application Data
(60) Provisional application No. 63/019,625, filed on May 4, 2020.

(51) Int. Cl. B67D 1/08; B67D 1/00

(52) U.S. Cl. CPC B67D 1/0888; B67D 1/0884; B67D 1/0027

(57) ABSTRACT

A system to accurately and cost effectively monitor the level of syrup in a BIB and ensure proper mixture.

### CROSS-REFERENCE

The present patent application is based upon and claims the benefit of provisional patent no. 63/019,625, filed May 4, 2020.

### BACKGROUND OF THE INVENTION

Beverage post-mix systems are commonly found in restaurants, carryout's, hotels and any other operation that provides mass quantity beverages such as soda and frozen drinks. The systems commonly operate using syrups contained in what is commonly known as a bag in the box (BIB). Water enters the carbonator where carbon dioxide (CO2) is forced into the water under pressure. Once CO2 is absorbed into the water, the carbonated water then travels through the fountain machine where it is cooled to below 40-degrees Fahrenheit, and then piped to the dispense nozzle. The syrup concentrates are mixed with carbonated fluids such as water and are delivered to a dispensing apparatus. The syrup is in a bag stored in a box on a rack in the back of the store or under a counter. Pneumatic pumps pull the syrup out of the bag and then push the syrup through a feed line to a fountain machine. The pumps use pressurized air or CO2 to pump the syrup to the fountain machine. With the valve closed at the fountain machine, the syrup pressurizes the line at a pressure equal to the CO2 or pressurized air feed to the pump. As the valve on the fountain machine opens, syrup is released and blended with carbonated water creating soda. The syrup pump piston moves to push the syrup at the set pressure up the syrup feed line. At the end of the syrup pump piston stroke, it reverses direction and the CO2, or pressurized air, used for that volume is exhausted. More CO2, or pressurized air, is used to push the piston in the opposite direction. This provides a constant feed of syrup at the set pressure to the fountain machine and creates two exhaust pulses per pump cycle volume. A similar method is also used on machines that dispense frozen soda, such as the Speedy Freeze.

The inability to monitor product levels in soda syrup containers (BIB) can result in poor customer experiences or product loss. If the BIB runs empty, a customer will receive an off-specification beverage. Attempts to monitor the syrup levels in the BIB have included load cells, PLCs, and flow valves, all of which can be very complicated and expensive. Usually, the post mix system is separate from the dispensing apparatus, so constant vigilance is required to make sure that the BIB's do not run out of syrup. Furthermore, employees may err on the side of caution and discard a BIB while it still contains significant amounts of syrup. This results in waste and a loss of syrup which is expensive and affects subsequent sales of products. Prior to the present invention, fountain drink sales were only able to be recorded by advertised volume. The present invention makes it possible to detect the specific product and actual volume of said product. An observed 30 oz fountain beverage uses only 21 oz's of product as the rest of the volume is displaced by ice. This allows for various operational cost efficiencies in the form of improved waste management, better maintenance visibility into customer trends and better targeted offers by stores.

There is a need for a system to accurately and cost effectively monitor the level of syrup in the BIB.

### BRIEF DESCRIPTION OF THE DRAWINGS

FIG. 1 is a perspective view of the apparatus of the present invention.

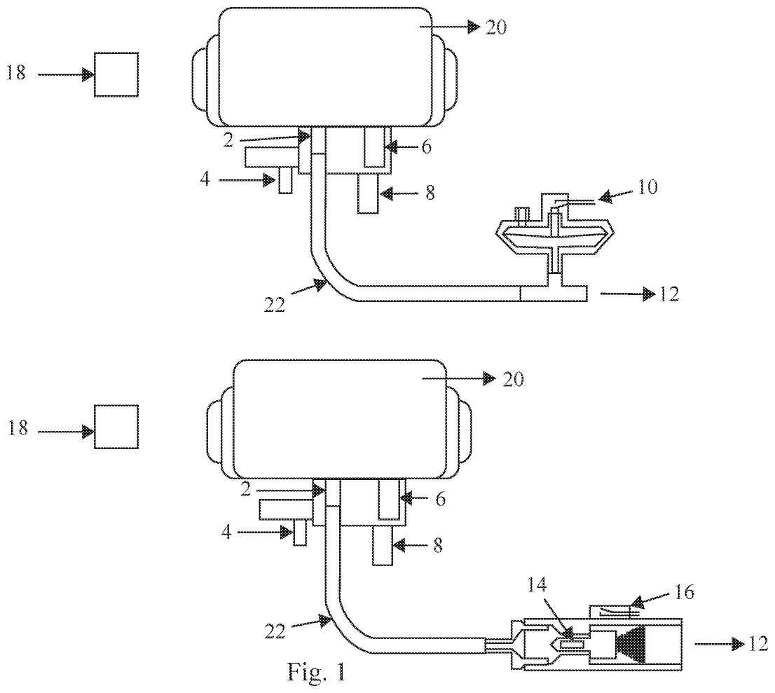

### DESCRIPTION OF THE INVENTION

The syrup is commonly driven from the BIB by pressurized gas, such as CO2, which is delivered in pulses powered by fluid pumps. The invention provides a system for monitoring syrup in the BIB. One aspect of the invention monitors the exhaust pulses of the pumps associated with the BIB. In a beverage dispensing system, a pump is used to move the syrup from the BIB to the fountain. These pumps use CO2 as a drive mechanism. The CO2 is discharged into the atmosphere through an exhaust port. This portion of the invention places a switch or sensor on the exhaust port of each pump. The switch or sensor is capable of determining when an exhaust occurs. From the exhaust data, the amount of syrup being driven by each pump pulse or exhaust can be calculated. The pulsing switch or sensor is in contact with a programmable logic computer (PLC). The PLC will communicate in real time, at all levels, with the individual stores and also, if desired, at the larger corporate level.

The CO2 operated pumps release exhaust CO2 at the rate of one or two pulses per cycle, depending on the pump design. Since these are fixed displacement pumps, counting the pulses will yield a volume equivalent to displacement per cycle of the pump divided by exhaust pulses per cycle. This measurement will provide accurate details of volume displacement in each BIB. The exhaust pulses will be detected either by operating a sensor and the change of state will be detected by a PLC. A water flow meter may be added to the water feed into the fountain machine to record the volume of water consumed. This data will be relayed to the PLC. The additional data will be used to verify fountain blend ratio adjustments and accuracy. The type of pneumatic syrup pump per product and the products blend ration are typically static and will be recorded at the time the system is installed. The flow of exhaust from the pump will create a condition that can be recorded by the PLC as a change of state. The water volume would be recoded by the PLC as volume. All data collected by the PLC will be relayed to a central computer that can analyze local storage and consumption. Using the exhaust pulses of the pump, the PLC will calculate the amount of syrup being consumed in real-time. The volume of exhaust of the most common BIB pumps I s 1.25 oz, 1.6 oz, and 1.7 oz per exhaust stroke. The volume and time the pulse is recorded can then be used to calculate the volume of each product being mixed and the time it is being mixed. The product blend rations can then be verified with eh water volume consumed.

A second aspect of the invention is to provide photocell resistors in the BIB rack to determine whether a BIB is present in BIB rack array. This allows the operators to determine, via the PLC readout, when a BIB is replaced in order to reset the pulse count automatically.

Another aspect of the invention provides load cells upon which each BIB rests. The load cells measure the weight of the BIB and can provide data to the PLC regarding the weight of the BIB which can be extrapolated to determine how much syrup remains in the BIB.

The PLC will be connected to a local display which will alert local users when a BIB reaches a predetermined empty level so that the BIB can be replaced. Further, the local display with provide a real-time display of the levels of each BIB, not dissimilar to a gas gauge. This will allow the local user to change a BIB before it becomes empty. Further, when the system detects an upcoming surge in sales, based on prior data, the local display can prompt the local user to change a BIB even if it has not reached the predetermined empty level.

The combination of the exhaust pulse sensors to count the amount of syrup bring driven to the dispensers with the photocell resistors to detect whether the BIB is present in the rack along with a load cell to monitor the fluctuating weight of the BIB as product is used, provide many great opportunities to reduce the need for user input and make the entire post-mix dispensing system more automatic. For instance, the invention provides for the following capabilities:

monitoring of the CO2 usage to determine the remaining volume in the CO2 bulk tank;

the PLC is programmable to automatically order additional syrup as needed to prevent any problems with running out of syrup;

the automatic reordering system is based on the data fed by the combined exhaust sensor, photocell sensor, and load cell;

the data allows the operators of the fountain dispensing system to program the PLC to predict fluctuating sales volume, allowing for preemptive restocking dictated by future events that would trigger larger than normal sales volumes;

mobile alerting to operators and managers of low volume of syrup in the BIBs;

alerting of maintenance issues for the operating pumps or for frozen carbonated beverage outages; and

soda flavor offerings optimization to improve the accuracy of placing the correct soda types in various regions or stores that prefer one flavor over another based-on usage.

We claim:

1. An automated system for monitoring syrup levels and blend accuracy in a beverage dispensing system comprising, in combination:
a beverage dispenser;
a CO2 operated fluid pump having at least one exhaust port;
a sensor in communication with the at least one exhaust port of the CO2 operated fluid pump;
a PLC in communication with the CO2 operated fluid pump and sensor;
a display capable of displaying the syrup levels in real time;
wherein the sensor measures the exhaust from the CO2 operated fluid pump and the PLC calculated the amount of syrup dispensed in real time,
the syrup levels are then conveyed to a display.

2. The apparatus of claim 1 further including a photocell resistor that measure light to indicate that a syrup box (BIB) has been replaced. Wherein the PLC communicates with the display to indicate that the syrup level is now full.

3. The apparatus of claim 1 further including a water flow meter added to the water feed into the fountain machine to record the volume of water consumed.

4. The apparatus of claim 1 further including the PLC verify fountain blend ratio adjustments and accuracy.
